(19) United States
(12) Patent Application Publication
(10) Pub. No.: US 2026/0350712 A1
(43) Pub. Date: Nov. 5, 2026

(54) Generative Artificial Intelligence Systems and Methods for Linking Insurance Endorsements to Policy Forms

(71) Applicant: Insurance Services Office, Inc., Jersey City, NJ (US)

(72) Inventors: Miao Li, New York, NY (US); Pradeep Ghimire, Toronto (CA); Ashish Nangpal, Belle Mead, NJ (US); Deepika Vasu Kumar, Jersey City, NJ (US); Kishore Reddy Yaramala, Andhra Pradesh (IN)

(73) Assignee: Insurance Services Office, Inc., Jersey City, NJ (US)

(21) Appl. No.: 19/661,906

(22) Filed: Apr. 29, 2026

Related U.S. Application Data
(60) Provisional application No. 63/798,208, filed on May 1, 2025.

(51) Int. Cl. G06Q 40/08

(52) U.S. Cl. CPC G06Q 40/09

(57) ABSTRACT

Generative artificial intelligence systems and methods for linking insurance endorsements to policy forms are provided. The system automatically identifies, analyzes, and links endorsement modifications to their corresponding policy sections using natural language processing and generative AI techniques. Such features allow the system to automatically distinguish actions and data payloads in endorsements, and to integrate modifications of endorsements into the original policy forms. The system retrieves policy data, maps endorsements to policy data, extracts endorsement structures, detects action slices and payloads, extracts text hierarchy, links action slices to forms, performs data integration, and allows a user to rapidly identify, view, and integrate endorsements within existing policies in a customized, easy-to-use user interface.

### RELATED APPLICATIONS

The present application claims The benefit of U.S. Provisional Application Ser. No. 63/798,208 filed on May 1, 2025, the entire disclosure of which is expressly incorporated herein by reference.

### BACKGROUND

### Technical Field

The present disclosure relates generally to the field of generative artificial intelligence. More specifically, the present disclosure relates to generative artificial intelligence systems and methods for linking insurance endorsements to policy forms.

### Related Art

In the insurance field, insurance professionals and stakeholders often must manually review extensive policy documents to understand and implement various insurance-related actions, such as endorsement modifications. This results in significant inefficiencies in policy management and interpretation. Moreover, traditional approaches rely on manual review and basic keyword matching, which can lead to high operational costs, increased error rates, and substantial time investments.

The field of artificial intelligence, and in particular, generative artificial intelligence, is growing tremendously, and technologies in these areas are rapidly enhancing the speed with which useful data can be generated. However, such technologies have not yet effectively been incorporated into computer-based insurance authoring and/or policy management systems, where there is a significant need for improving the speed and accuracy with which computer systems can identify and link insurance endorsements to insurance policy forms.

Accordingly, what would be desirable, but have not yet been provided, are generative artificial intelligence systems and methods for linking insurance endorsements to policy forms, which address the foregoing and other needs.

### SUMMARY

The present disclosure relates to generative artificial intelligence systems and methods for linking insurance endorsements to policy forms. The system automatically identifies, analyzes, and links endorsement modifications to their corresponding policy sections using natural language processing and generative AI techniques. Such features allow the system to automatically distinguish actions and data payloads in endorsements, and to integrate modifications of endorsements into the original policy forms. The system retrieves policy data, maps endorsements to policy data, extracts endorsement structures, detects action slices and payloads, extracts text hierarchy, links action slices to forms, performs data integration, and allows a user to rapidly identify, view, and integrate endorsements within existing policies in a customized, easy-to-use user interface.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating overall processing steps carried out by the systems and methods of the present disclosure;

FIG. 3 is a flowchart illustrating step 38 of FIG. 2 in greater detail;

FIG. 4 is a flowchart illustrating step 40 of FIG. 2 in greater detail;

FIG. 5 is a flowchart illustrating step 46 of FIG. 2 in greater detail; and

FIG. 6 is a screenshot illustrating a user interface screen generated by the systems and methods of the present disclosure.

### DETAILED DESCRIPTION

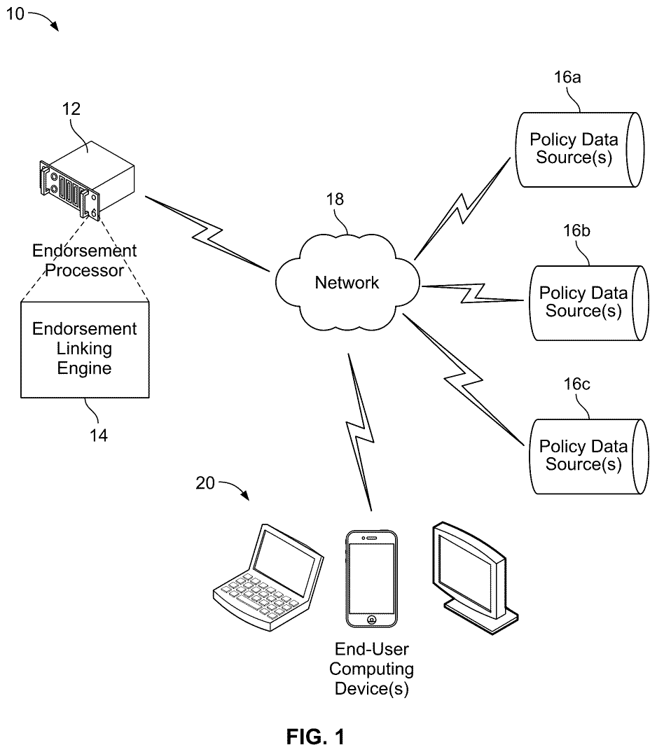

The present disclosure relates to generative artificial intelligence systems and methods for linking insurance endorsements to policy forms, as described in detail below in connection with FIGS. 1-6.

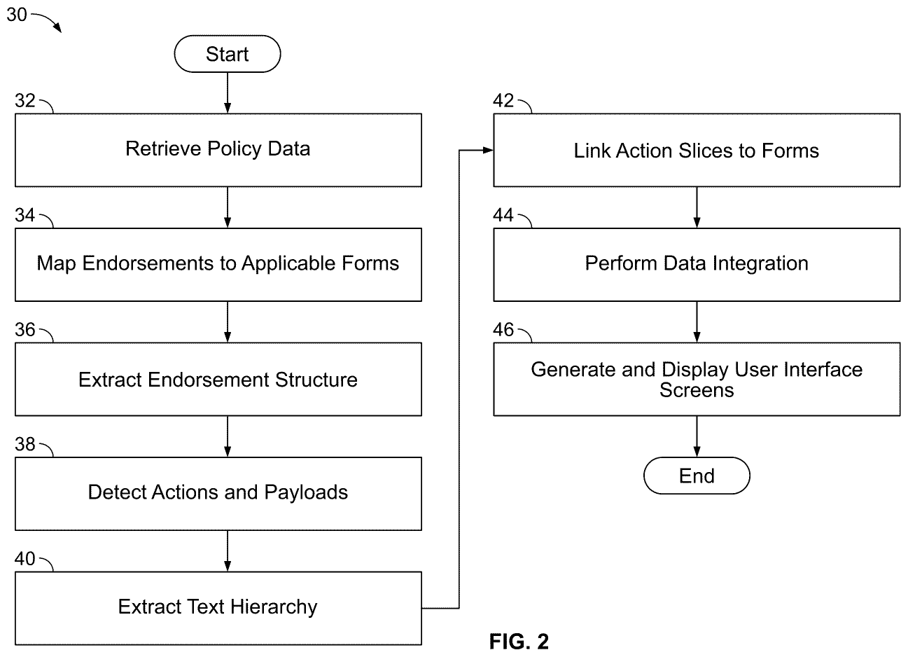

FIG. 1 is a diagram illustrating the system of the present disclosure, indicated generally at 10. The system 10 includes an endorsement processor 12 that executes an endorsement linking software engine 14. The endorsement processor 12 and the endorsement linking software engine receive and process insurance policy data from one or more policy data sources 16a-16c that are in communication with the processor 12 via a network 18, such as the Internet, a local area network, a wide area network, a cellular data communications network, an intranet, or other suitable type of network. As will be discussed in greater detail below in connection with FIGS. 2-6, the processor 12 and the engine 14 are an artificial intelligence (AI) powered system that automatically identifies, analyzes, and links endorsement modifications to their corresponding policy sections using natural language processing and generative AI techniques. Such features allow the system to automatically distinguish actions and data payloads in endorsements, and to integrate modifications of endorsements into the original policy forms.

The processor 12 could be any suitable computing device capable of executing the engine 14 and performing the steps discussed herein, including, but not limited to, a desktop computer, a laptop computer, a tablet computer, a smart phone, a server, a cloud-based computing platform, or other suitable type of computing system or environment. The engine 14 could be embodied as non-transitory, computer-readable instructions stored in a suitable memory or storage medium and executable by the processor 12, and could be coded in any suitable high-or low-level computer programming language, including, but not limited to, C, C++, C#, Java, Python, or any other suitable language. Moreover, the engine 14 could be embodied as a hardware device such as a field-programmable gate array (FPGA), an application-specific integrated circuit (ASIC), or other suitable hardware device. The processor 12 can communicate with one or more end-user computer devices 20, such as desktop computers, laptop computer, tablet computers, smart phones, etc., so that the users of such devices can interact with the systems and methods of the present disclosure using a suitable user interface, which could be web-based (e.g., hosted by the processor 12 or other device such as a web server) and/or by way of a customized software application executed by the devices 12. The end-user devices 20 can communicate with the processor 12 via the network 18. Still further, the engine 14 could be executed directly by the end-user devices 20, in which circumstance the processor 12 need not be provided and the end-user computing devices 20 can communicate with the policy data sources 16a-16c via the network 18. The data sources 16a-16c store insurance policy and endorsement information processed by the systems and methods of the present disclosure.

FIG. 2 is a flowchart illustrating overall processing steps, indicated generally at 30. carried out by the systems and methods of the present disclosure. In step 32, the system retrieves policy data from a suitable data source, such as from one or more of the policy data sources 16a-16c. Next, in step 34, the system maps one or more endorsements to one or more applicable forms. The mapping could be stored in a pre-defined database table or other data structure, such that specific endorsements are linked by the system to specific types of policies. Then, in step 36, the system extracts the endorsement structure from the one or more endorsements. This step could be performed by detecting policy reference sections of the policy text, as well as schedules and main text from the policy document. In particular, in step 36, the system detects endorsement title, policy reference sections, schedules, and the main body of the policy document using pre-defined text patterns that the system is programmed to search for. In step 38, the system detects one or more actions and associated data payloads. In step 40, the system extracts text hierarchy, then in step 42, the system links action slices to forms. Specifically, in step 42, the system extracts an outline from matching policy forms down the clause level, and then processes the extracted outline using a pre-trained generative AI model to link the location referenced in the action slice (obtained in step 38) with the corresponding clauses and/or sections in the policy form. For more complex cases of multilevel action slices, the system utilizes a triage process for linking. In step 44, the system performs data integration, and finally, in step 46, the system generate and displays one or more user interface screens which graphically link endorsements to a particular policy. It is noted that, in step 44, the system stores the processed data in a database, including matched endorsements and policy pairs, labels of actions and payloads, hierarchy information, detected actions and locations in each action slice, and linking identifiers for each action slice, for future usage by the system of the present disclosure and/or other systems in communication with the system of the present disclosure.

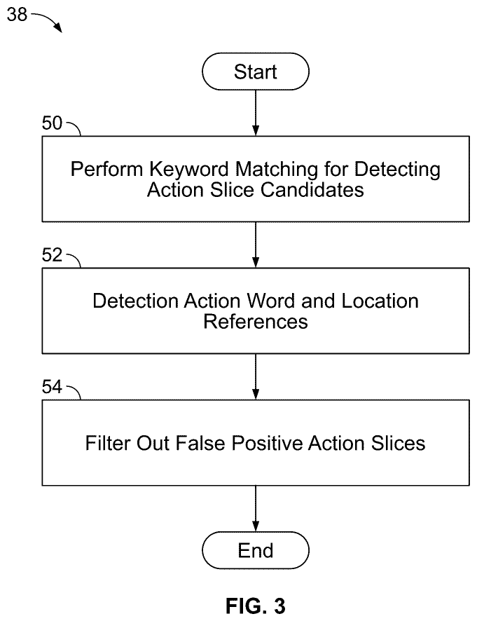

FIG. 3 is a flowchart illustrating step 38 of FIG. 2 in greater detail. In step 50, the system performs keyword matching for detecting action slice candidates. Action slice candidates define portions of the policy text in which the system will detect specific action words, which are words that are likely to indicate an event relevant to one or more endorsements. Additionally, each paragraph in a document could be determined by the system to correspond to a slice. Next, in step 52, the system detects the action words and location references (e.g., locations within the policy text where the action words are identified) using a pre-trained generative AI model that is trained to detect action words and locations for each action slice. Finally, in step 54, the system filters out false positive action slice, also using a pre-trained generative AI model.

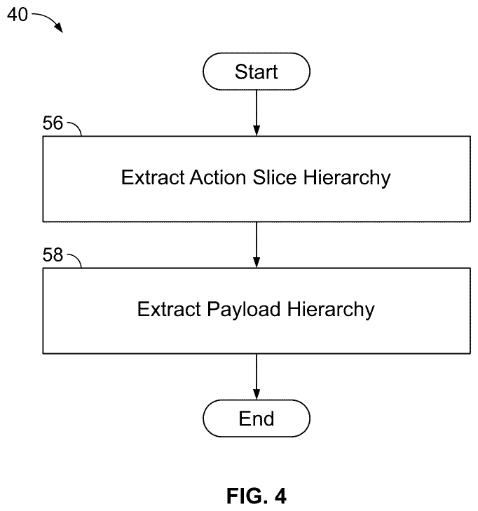

FIG. 4 is a flowchart illustrating step 40 of FIG. 2 in greater detail. In step 56, the system extracts a hierarchy of action slices. The hierarchy indicates all of the slices that are identified by the system from the policy, as well as the relationships between the slices. Next, in step 58, the system extracts a payload hierarchy. The payload hierarchy indicates all of the payload data extracted from the policy, as well as the relationships between the payloads and the relationships between the payload data and the action slices.

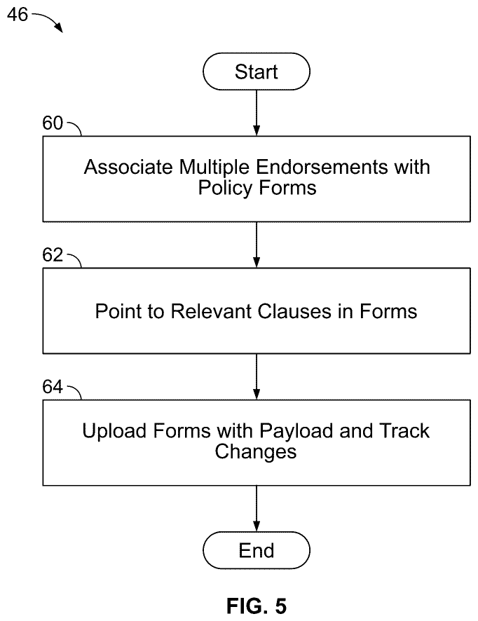

FIG. 5 is a flowchart illustrating step 46 of FIG. 2 in greater detail. In step 60, the system associates multiple endorsements with policy forms. Then, in step 62, the system identifies (or “points to,” within the user interface) relevant clauses in the form for each action slice. Finally, in step 64, the system updates the form with the payload and tracks the change (e.g., graphically indicating the change on the policy).

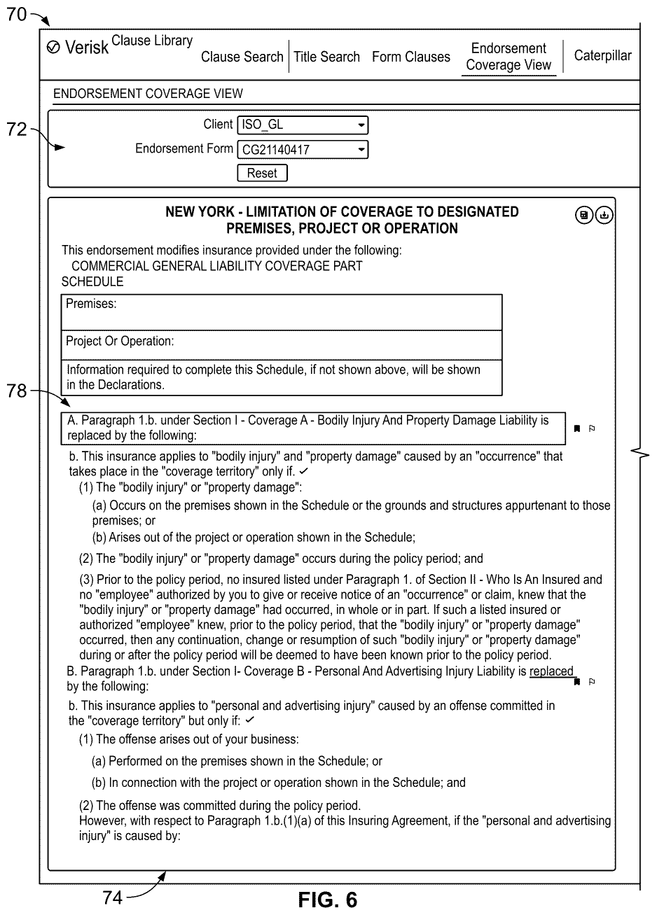

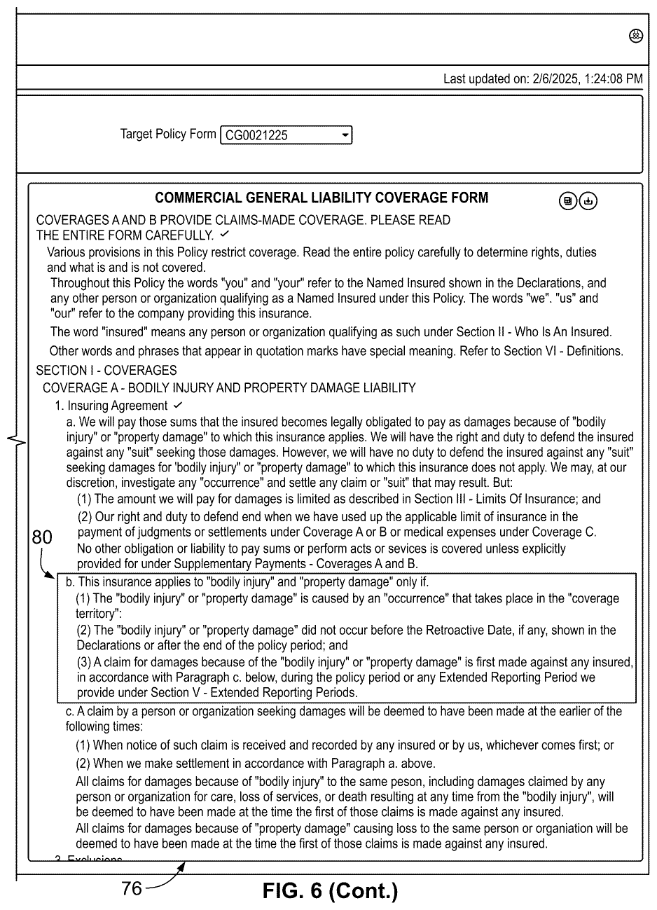

FIG. 6 is a screenshot illustrating a user interface screen, indicated generally at 70, generated by the systems and methods of the present disclosure. As can be seen, the screen 70 includes a user input panel 72 which allows the user to specify a client and a desired endorsement form, as well as a target policy form. Once these parameters are specified, the system displays an endorsement display panel 74 and a policy display panel 76 adjacent to the endorsement display panel 74. In the endorsement display panel 74, the user can scroll through various endorsements and can select a desired endorsement to be linked to a policy by clicking on one of the endorsements. As can be seen in the panel 74, the user has selected (clicked on) an endorsement 78 which relates to bodily injury and property damage liability. When the endorsement 78 is selected, the system automatically parses the policy displayed in panel 76 to identify a portion 80 of the policy text that is related to the selected endorsement 78, thereby automatically linking the endorsement 78 to the policy displayed in the panel 76. The portion 80 is graphically highlighted to the user, and can be altered/edited and saved by the user, as desired.

The systems and methods of the present disclosure provide many benefits. For example, the system greatly reduces policy review and processing time, increases the accuracy of policy modification implementation and validation, and enables rapid policy updates and tracking. Additionally, the system achieves complex contextual understanding that is impossible with existing, rule-based computer systems, thereby providing a significant technological improvement in such systems. Also, the system improves the accuracy of action and payload detection over traditional keyword matching techniques. Still further, the system enables scalable processing of endorsements, allowing for more rapid processing of endorsements with less computational resources required.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A generative artificial intelligence system for linking insurance endorsements to policy forms, comprising:
an endorsement processor; and
an endorsement linking software engine executed by the endorsement processor, the endorsement linking software engine causing the processor to perform steps of:
receiving insurance policy data;
mapping one or more endorsements of the policy data to one or more applicable forms;
extracting an endorsement structure from the one or more endorsements;
detecting one or more actions and associated data payloads;
extracting a text hierarchy and linking action slices to one or more forms using a pre-trained generative artificial intelligence (AI) model; and
generating and displaying a graphical user interface screen, the graphical user interface screen graphically linking the one or more endorsements with an insurance policy.

2. The system of claim 1, wherein the step of detecting one or more actions and associated data payloads comprises:
performing keyword matching to detect action slice candidates;
detecting action words and location references using a pre-trained generative AI model trained to detect action words and locations from action slices; and
filtering out false positive action slices using the pre-trained generative AI model.

3. The system of claim 2, wherein the action slice candidates define portions of policy text in which action words are to be detected by the system, the action words indicating an event relevant to the one or more endorsements.

4. The system of claim 1, wherein the step of extracting the text hierarchy comprises extracting a hierarchy of action slices and relationships between the action slices, and extracting a payload hierarchy.

5. The system of claim 4, wherein the payload hierarchy indicates all payload data extracted from a policy, relationships between the payload data, and relationships between the payload data and action slices.

6. The system of claim 1, wherein the graphical user interface screen comprises a user input panel, an endorsement display panel, and a policy display panel positioned adjacent to the endorsement display panel.

7. The system of claim 6, wherein the user input panel allows a user to specify a client, a desired endorsement form, and a target policy form.

8. The system of claim 7, wherein the endorsement display panel displays one or more endorsements and allows the user to select one of the endorsements.

9. The system of claim 8, wherein the policy display panel displays a portion of text of the one or more endorsements related to the one or more endorsements selected by the user in the endorsement display panel.

10. The system of claim 9, wherein the policy display panel graphically highlights the portion of text to the user.

11. A generative artificial intelligence method for linking insurance endorsements to policy forms, comprising:
receiving by an endorsement processor insurance policy data;
mapping by the endorsement processor one or more endorsements of the policy data to one or more applicable forms;
extracting by the endorsement processor an endorsement structure from the one or more endorsements;
detecting by the endorsement processor one or more actions and associated data payloads;
extracting by the endorsement processor a text hierarchy and linking action slices to one or more forms using a pre-trained generative artificial intelligence (AI) model; and
generating and displaying by the endorsement processor a graphical user interface screen, the graphical user interface screen graphically linking the one or more endorsements with an insurance policy.

12. The method of claim 11, wherein the step of detecting one or more actions and associated data payloads comprises:
performing keyword matching to detect action slice candidates;
detecting action words and location references using a pre-trained generative AI model trained to detect action words and locations from action slices; and
filtering out false positive action slices using the pre-trained generative AI model.

13. The method of claim 12, wherein the action slice candidates define portions of policy text in which action words are to be detected by the system, the action words indicating an event relevant to the one or more endorsements.

14. The method of claim 11, wherein the step of extracting the text hierarchy comprises extracting a hierarchy of action slices and relationships between the action slices, and extracting a payload hierarchy.

15. The method of claim 14, wherein the payload hierarchy indicates all payload data extracted from a policy, relationships between the payload data, and relationships between the payload data and action slices.

16. The method of claim 11, wherein the graphical user interface screen comprises a user input panel, an endorsement display panel, and a policy display panel positioned adjacent to the endorsement display panel.

17. The method of claim 16, wherein the user input panel allows a user to specify a client, a desired endorsement form, and a target policy form.

18. The method of claim 17, wherein the endorsement display panel displays one or more endorsements and allows the user to select one of the endorsements.

19. The method of claim 18, wherein the policy display panel displays a portion of text of the one or more endorsements related to the one or more endorsements selected by the user in the endorsement display panel.

20. The method of claim 19, wherein the policy display panel graphically highlights the portion of text to the user.
